(19) United States
(12) Patent Application Publication
(10) Pub. No.: US 2022/0169309 A1
(43) Pub. Date: Jun. 2, 2022

(54) HEAVY-DUTY VEHICLE

(71) Applicant: GOLDHOFER AG, Memmingen (DE)

(72) Inventor: Horst HÄFELE, Babenhausen (DE)

(73) Assignee: GOLDHOFER AG, Memmingen (DE)

(21) Appl. No.: 17/442,066

(22) PCT Filed: Mar. 17, 2020
(86) PCT No.: PCT/EP2020/057312

§ 371 Date: Sep. 22, 2021

(30) Foreign Application Priority Data
Mar. 29, 2019 (DE) 10 2019 204 442.5

(51) Int. Cl. B62D 13/02; B62D 13/04; B62D 53/08

(52) U.S. Cl. CPC B62D 13/025; B62D 53/0842; B62D 13/04

(57) ABSTRACT

A heavy-duty vehicle, comprising a steering unit mounted on a vehicle frame of the heavy-duty vehicle, wherein the steering unit is rotatable about an axis of rotation of the steering unit. The heavy-duty vehicle comprises a steering input element connected to the steering unit and configured to cause the steering unit to rotate about the axis of rotation of the steering unit. The steering unit has at least one connecting portion configured to be connected to one or more of a steering device of the heavy-duty vehicle or the steering input element of the heavy-duty vehicle. The steering unit comprises at least one actuating unit configured to change a distance of at least one connecting portion relative to the axis of rotation of the steering unit.

The invention relates to a heavy-duty vehicle which comprises a steering unit which is mounted on a vehicle frame of the heavy-duty vehicle to be rotatable about an axis of rotation and which has at least one connecting portion which is configured to be connected to a steering device and/or a steering input element of the heavy-duty vehicle.

It should be noted at this point that the heavy-duty vehicle can be both a motor-driven heavy-duty vehicle and a towed heavy-duty vehicle, for example a heavy-duty trailer or, as described in Annex XI to EC Directive 2007/46/EC in the version dated 15.07.2011, an “exceptional load transport trailer”, i.e. according to the definition of this term given there, a vehicle of class O4 for the transport of divisible and indivisible loads (e.g. construction machinery, containers and rotor blades of wind turbines) which are subject to speed and traffic restrictions due to their dimensions, this also including modular trailers, regardless of the number of axles and modules. It should also be noted that, even in the case of motor-driven heavy-duty vehicles, not every axle assembly needs to be motor-driven.

In addition, only those vehicles are regarded as heavy-duty vehicles in the sense of the present invention, in which the load for which each individual axle assembly has to be designed has a value of at least 4 t, preferably at least 5 t, more preferably at least 6 t.

Such heavy-duty vehicles often have a large number of axle assemblies, depending on the load to be transported, which in turn results in a large length of the heavy-duty vehicle. In addition, the length of the heavy-duty vehicle can differ from one use to another, for example it can be changed by means of a telescopic central longitudinal member or by arranging a loading ramp or other such components. The great length makes it difficult to adjust the individual axle assemblies to the optimal steering rotation angle about the steering axis when cornering.

From the prior art, super-heavy vehicles are known which have devices to transmit a relative rotation between two vehicle elements, such as a tractor unit and a semi-trailer, using an adjustable transmission ratio to a steering device. For example, EP 2 674 349 B1 discloses a steering plate which is non-rotatably connected to a semi-trailer coupling of the tractor unit and to which a variable in length actuating unit is firmly connected, at the free end of which a steering actuator is arranged for connection to a steering device. Because herein the variable in length actuating unit is firmly connected to the steering plate, the design of the actuating unit is severely restricted, for example with regard to its size. Furthermore, this means that advantageous developments are not possible or only possible with great design effort, such as the provision of a plurality of steering devices.

It is therefore the object of the present invention to provide a heavy-duty vehicle which has a simplified and more readily developed transmission of a steering angle of a first vehicle part to a steering device of a second vehicle part.

According to the invention, this object is achieved by a heavy-duty vehicle, comprising a steering unit which is mounted on a vehicle frame of the heavy-duty vehicle to be rotatable about an axis of rotation and which has at least one connecting portion which is configured to be connected to a steering device and/or a steering input element of the heavy-duty vehicle and the steering input element, which is connected to the steering unit and is configured to cause a rotation of the steering unit about its axis of rotation, the steering unit comprising at least one, preferably variable in length, actuating unit which is configured to change a distance of at least one connecting portion relative to the axis of rotation of the steering unit.

The steering device can be connected to the steering unit in an articulated manner at the connecting portions so that, for example, a rotation of the steering unit initially causes a substantially axial displacement of the portion of the steering device attached to the steering unit. On a further rotation of the steering unit, the portions of the steering device arranged on the connecting portions will naturally also be able to undergo a rotational displacement.

In particular, the heavy-duty vehicle according to the invention can enable a steering angle input by the steering input element into the steering unit using the variable in length actuating unit in a variable transmission ratio to be transferred to a steering device associated with the variable in length actuating unit. In other words, the variable in length adjusting unit is configured to change a ratio in which a rotation of the steering unit causes a displacement, that is a steering, of the steering device, by changing the length of the variable in length actuating unit.

It should also be mentioned that the steering input element can input a steering angle into the steering unit in different ways. The steering input element can thus be connected in a stationary manner to a first vehicle part which rotates relative to a second vehicle part on which the steering unit and/or the steering device is/are arranged. However, it is also conceivable that the steering input element comprises an actuator which can convert a signal, for example an electrical signal, into an actuation of the actuator and thus a rotation of the steering unit. In the latter case, for example, an element that is non-rotatably connected to the first vehicle part and rotatably connected to the second vehicle part can be dispensed with.

The variable in length actuating unit can be configured both to displace the at least one connecting portion associated therewith continuously and also in a stepped manner. For example, it can be conceivable that the at least one connecting portion, which can be displaced relative to the steering unit, has a predetermined number of positions to be assumed, for example two end stops of a movement path associated with a particular connecting portion.

The steering input element can be connected to the steering unit via a coupling unit which is connected to the steering unit eccentrically to the axis of rotation of the steering unit, the coupling unit being able to connect the steering input element to the steering unit in such a way that a displacement of the steering input element relative to the vehicle frame of the heavy-duty vehicle causes a rotation of the steering unit relative to the vehicle frame of the heavy-duty vehicle. The coupling unit can be connected to the steering unit in an articulated manner in order to be able to separate a rotational displacement of the coupling unit from a rotation of the steering unit. The coupling unit can be designed as a coupling rod, for example, wherein a displacement of the steering input element can preferably cause a substantially axial displacement of the coupling unit, whereby the steering unit can in turn be set in rotation.

In particular, the steering input element can be designed as a steering actuator rotatable about an axis of rotation stationary to the vehicle frame of the heavy-duty vehicle and arranged at a substantially unchangeable distance from the axis of rotation, the steering actuator defining a pivot axis for the coupling unit connected to the steering actuator. The axis of rotation of the steering input element can thus be different from the axis of rotation of the steering unit and, in particular, offset from it by an unchangeable distance. In particular, the axis of rotation of the steering input element cannot be configured to coincide with the steering input element.

The heavy-duty vehicle can further comprise a steering plate which is configured to be rotated relative to the vehicle frame of the heavy-duty vehicle about the stationary axis of rotation dependent upon a steering angle of the heavy-duty vehicle, the steering actuator being connected to the steering plate eccentrically to the axis of rotation of the steering plate. The steering plate, which is non-rotatably connected, for example, to a first vehicle part that is pivotable relative to the vehicle frame of the heavy-duty vehicle, can, when the first vehicle part rotates relative to the vehicle frame of the heavy-duty vehicle, rotate together with the first vehicle part, i.e. in the same way relative to the vehicle frame of the heavy-duty vehicle. This rotation of the steering plate can cause the steering actuator to rotate relative to the vehicle frame of the heavy-duty vehicle by the same angle as the steering plate. For this purpose, the steering actuator can be designed as a rod which is connected in a stationary manner and non-rotatably to the steering plate and around which the coupling unit is pivotably mounted on its side facing away from the steering unit.

In a further development of the present invention, the heavy-duty vehicle can comprise a further steering device, and the steering unit can be connected to both the one steering device and to the further steering device, wherein the variable in length actuating unit of the steering unit can be configured to displace at least one connecting portion associated with the one steering device, in particular all the connecting portions associated with the one steering device relative to the axis of rotation of the steering unit. It is therefore possible by means of the present invention to actuate two steering devices which are, for example independent of one another, via a single displacement of the steering input element. The variable in length actuating unit of the steering unit associated with the one steering device can set the transmission ratio between a steering angle input by the steering input element or a rotation angle of the steering unit, respectively, with respect to a steering of the one steering device. The transmission ratio associated with the further steering device can remain unchanged. It is conceivable that the variable in length actuating unit translates steering in a first direction, for example to the left, differently from steering in a second direction, for example to the right. This can be realised, for example, by means of a variable in length actuating unit with at least two length-adjustable portions and, for example, a single or double-acting piston-cylinder arrangement associated with a particular length-adjustable portion.

Furthermore, the steering unit can comprise a further variable in length actuating unit which is configured to displace at least one connecting portion associated with the further steering device, in particular all connecting portions associated with the further steering device, relative to the axis of rotation of the steering unit.

At least one of the variable in length actuating units of the steering unit can be configured to displace a pair of connecting portions synchronously relative to the axis of rotation of the steering unit. This means that activation of the variable in length actuating unit can bring about a simultaneous and, in particular, equal-length displacement of the pair of connecting portions relative to the axis of rotation of the steering unit. In this way, two steering circuits of a steering device, which must be present due to regulations and/or standards to be observed, for example, can be operated in a synchronous manner in order to achieve the same steering effect of the steering device by means of the two steering circuits.

Advantageously, a direction of change in length of at least one, in particular each, variable in length actuating unit of the steering unit can be oriented orthogonally to the axis of rotation of the steering unit. The direction of change in length is to be understood here as the direction and/or the axis in which the at least one variable in length actuating unit is elongated or shortened. A direction of change in length oriented orthogonally to the axis of rotation of the steering unit can, in particular, have a positive effect on an installation space required for the steering unit.

In particular, at least one of the variable in length actuating units can be configured as a hydraulic cylinder or double cylinder, respectively, or as a spindle drive or double spindle drive, respectively, or as a rack and pinion drive or as a linear unit or as a sliding block unit. A double cylinder can be both a cylinder with a single chamber in which two pistons are arranged, and a cylinder with a, for example centrally, separated chamber (i.e. two chambers), one piston being arranged in each chamber. A double spindle drive can be, for example, a spindle drive which comprises a spindle which has a thread with a first direction of rotation along a first portion and a thread with a second direction of rotation opposite to the first direction of rotation along a second portion, so that when the spindle rotates a spindle nut arranged on the first portion is displaced opposite to a spindle nut arranged on the second portion. In this example, the connecting portions can be connected to the spindle nuts in order to effect their displacement. Although the spindle only rotates with such a drive, so that the spindle nut is displaced thereon, such a drive is also regarded as “adjustable in length”, since the two portions of the drive connected to higher-level assemblies are displaced relative to one another.

In the rack and pinion drive, a toothed wheel rotating, for example, about an axis parallel to the axis of rotation of the steering unit, can be in engagement on two sides with toothed racks, which themselves are each associated with a connecting portion in order to displace during an actuation of the toothed wheel.

In particular, the double spindle drive and the rack and pinion drive can enable a positively coupled synchronisation of the connecting portions that are displaceable by the drive.

The sliding block unit can comprise a sliding block which is configured, for example, to be displaceable into predetermined end positions of a movement path. In this way, a stepped displacement of the connecting portions can be enabled.

The steering plate can furthermore comprise a kingpin and a steering wedge, which are configured to engage non-rotatably with a higher-level assembly, in particular a tractor unit that is not part of the heavy-duty vehicle, wherein, in particular, the axis of rotation of the steering plate can be substantially coaxial with a central axis of the kingpin. If the heavy-duty vehicle according to the invention is combined, for example, with a tractor unit, it is usual that the tractor unit has a semi-trailer coupling with which the heavy-duty vehicle according to the invention is to engage. As a counterpart to the semi-trailer coupling, kingpins are usually used, the heavy-duty vehicle remaining rotatable relative to the tractor unit. In order to prevent this rotation, it is proposed that a steering wedge of the heavy-duty vehicle also engages with the semi-trailer coupling of the tractor unit, for example in a widening opening through which the kingpin is guided into its end position. If the kingpin and steering wedge are in engagement with the semi-trailer coupling, a steering of the tractor unit is transmitted to the steering plate via the kingpin and the steering wedge. The steering plate, which is mounted rotatably about the stationary axis of rotation relative to the vehicle frame of the heavy-duty vehicle, can thereby transfer a steering of the tractor unit to the steering input element (or the steering actuator), which by means of its displacement causes a steering of the steering device(s) translated according to the position of the variable in length actuating unit(s).

Furthermore, a rotation of the steering plate relative to the vehicle frame of the heavy-duty vehicle about the axis of rotation of the steering plate and a resulting rotation of the steering unit about the axis of rotation of the steering unit can be aligned with respect to their respective direction of rotation. This can be achieved, in particular, in that the coupling unit takes up a displacement of the steering input element on the same side, in relation to a plane that runs through the axis of rotation of the steering unit and the axis of rotation of the steering input element, from the steering input element and also passes it on to the steering unit. For example, due to particular space requirements, it can also be conceivable that the two directions of rotation mentioned above are opposite.

The at least one variable in length actuating unit of the steering unit, viewed in a direction orthogonal to the axis of rotation of the steering plate, can advantageously be arranged outside the steering plate. In the case of a steering plate formed as a circular disk, a direction orthogonal to the axis of rotation of the steering plate can correspond to a radial direction of the steering plate. An arrangement of the steering unit outside the steering plate can promote protection of the steering unit against damage, since the steering unit per se, that is, the steering unit together with its axis of rotation, is not rotated relative to the vehicle frame of the heavy-duty vehicle. Furthermore, in this way, a conflict with other rotating parts which are arranged on the vehicle frame of the heavy-duty vehicle can be reduced or avoided.

In a further development of the present invention, at least one steering device to which the steering unit is connected can comprise a hydraulic circuit, and at least one of the connecting portions associated with this steering device can be connected to a piston-cylinder arrangement, wherein the piston-cylinder arrangement can be arranged in such a way that a rotation of the steering unit about the axis of rotation of the steering unit causes a relative displacement of piston and cylinder of the piston-cylinder arrangement, whereby the hydraulic circuit of this steering device can be actuated. Using piston-cylinder arrangements on the connecting portions can be a space-saving option for transmitting a rotation of the steering unit to a steering device.

The displacement of the piston and the cylinder of the piston-cylinder arrangement arranged on the steering unit can displace a fluid present in the cylinder of the piston-cylinder arrangement out of the cylinder into a fluid line or suck it out of the fluid line into the cylinder, wherein a further piston-cylinder arrangement connected to the corresponding piston-cylinder arrangement via the fluid line can be made to perform a relative displacement of piston and cylinder of the further piston-cylinder arrangement coupled to the piston-cylinder arrangement arranged on the steering unit. If, for example, due to a rotation of the steering unit and a displacement, associated therewith, of the piston in the cylinder of the piston-cylinder arrangement arranged there, fluid is displaced out of the cylinder, then the same amount of fluid is transferred into the cylinder of the further piston-cylinder arrangement, whereby the piston and a steering device connected thereto is actuated. In the event that the inner diameter of the cylinders of the piston-cylinder arrangement arranged on the steering unit and the further piston-cylinder arrangement are identical to one another, the displacement paths of the respective pistons can also be the same.

Furthermore, two piston-cylinder arrangements can be associated with each steering device, one of which is connected to the steering unit at one of the connecting portions arranged, in particular symmetrically, on both sides of a central plane which extends through the axis of rotation of the steering unit. As already mentioned above, it may be necessary, for example due to regulations and/or standards to be complied with, for each steering device to be actuated in a redundant manner. This can be achieved, for example, by means of two steering circuits of a steering device which are actuated in a synchronous manner in order thereby to achieve the same steering effect of the steering device by the two steering circuits. Here, when the steering unit rotates, the piston-cylinder arrangement can be pushed in on one side of the central plane (i.e. fluid is ejected from the cylinder), whereas the piston-cylinder arrangement on the other side of the central plane can be pushed out (i.e. fluid is sucked into the cylinder). As already described above, such a pushing in and/or pushing out of the piston-cylinder arrangements causes, in the event that the piston-cylinder arrangements are arranged opposingly in relation to their direction of extension, a correspondingly opposing actuation of the respective further piston-cylinder arrangements. The central plane here divides the steering unit substantially symmetrically into two halves in relation to the axis of rotation of the steering unit, that is, the central plane can also be viewed as the plane of symmetry of the connecting portions.

In this case, the respective ends of the piston-cylinder arrangements opposite the steering unit can be mounted on the same side of the plane rotatable about a common axis which, in particular, is substantially parallel to the axis of rotation of the steering unit. In this way, it can be made possible in a simple manner that a position of the piston-cylinder arrangements arranged on the steering unit is assumed in which all steering devices are geared equally.

It should also be added that the heavy-duty vehicle can also comprise a sensor system which is configured to detect a steering angle of the heavy-duty vehicle. For example, the sensor system can be configured to detect when a driver of the heavy-duty vehicle steers into a curve. Since a heavy-duty vehicle according to the invention designed as a trailer is not yet entering the curve at this point and should therefore continue to drive straight ahead for a certain distance until the curve, a closed loop/open loop control unit connected to the sensor system can actuate the at least one variable in length actuating unit in such a way that a relative rotation between the tractor unit and the trailer does not result in any actuation of the steering devices of the trailer. In other words, the relative rotation between the tractor unit and trailer can be compensated for by the variable in length actuating unit or the variable in length actuating units, respectively.

The sensor system of the heavy-duty vehicle can also be configured to determine, for example on the basis of a known length of the heavy-duty vehicle and a known speed of the heavy-duty vehicle, at what point in time the heavy-duty vehicle according to the invention, which here is configured as a trailer, enters the curve. At this point in time, the closed loop/open loop control unit can actuate the variable in length actuating unit in such a way that the steering device(s) of the trailer are actuated according to the radius of the curve, wherein in particular, the steering wheel of the tractor unit or a rotation angle between the tractor unit and trailer remain unchanged.

The same can of course apply to driving out of the curve, in which the driver of the tractor unit sets the steering of the tractor to drive straight ahead, whereas a steering device or steering devices, respectively, of the trailer should remain set for a cornering until the exit from the curve.

The behaviour described above is also generally known under the expression “remote steering”. However, the present invention can enable the means required for automatic steering, for example a corresponding “steering cylinder”.

Of course, it is also conceivable to actuate the wheels actuated by the steering devices of the heavy-duty vehicle configured, for example as a trailer, in a direction opposite to a steering of the wheels of a tractor unit, in order to enable a correspondingly smaller turning circle.

In the following, the present invention will be explained in more detail using an exemplary embodiment making reference to the accompanying drawings. In the drawings:

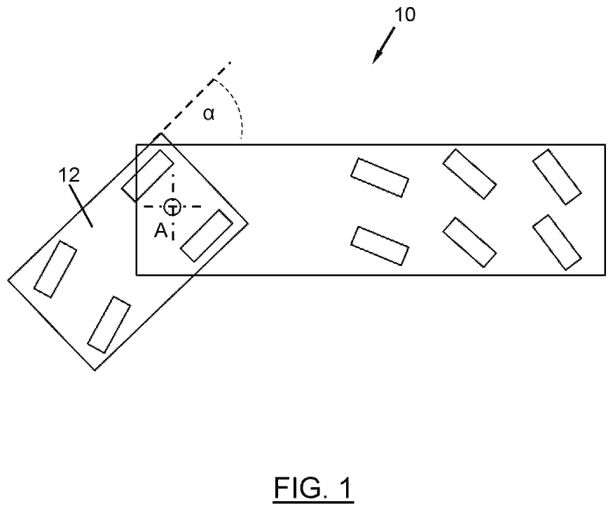

FIG. 1 shows a schematic structure of a heavy-duty vehicle according to the invention;

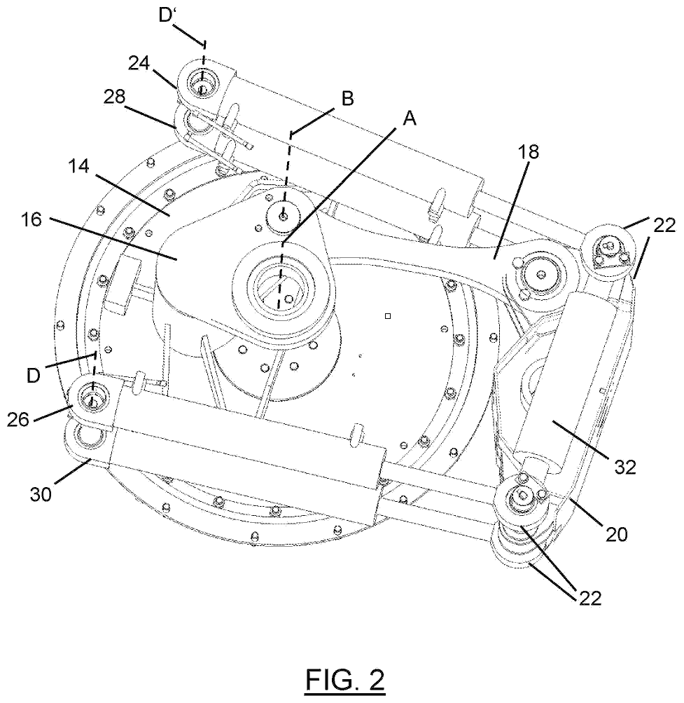

FIG. 2 shows a detail of the embodiment of the heavy-duty vehicle according to the invention as per FIG. 1 in a perspective view;

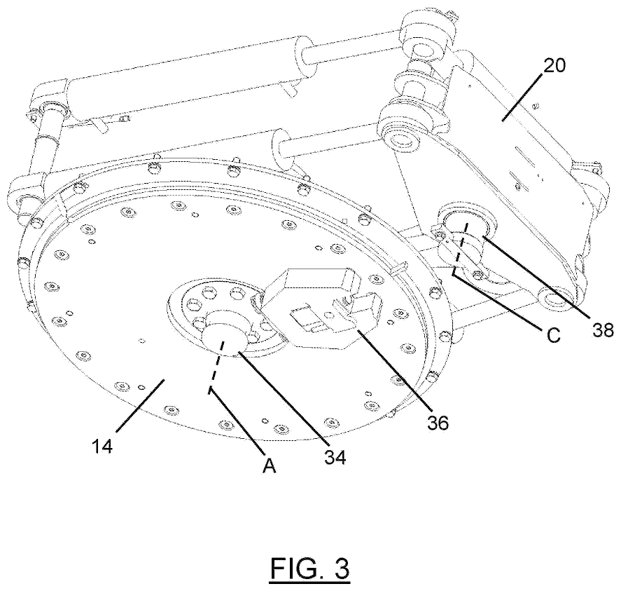

FIG. 3 shows the detail of FIG. 2 in a further perspective view;

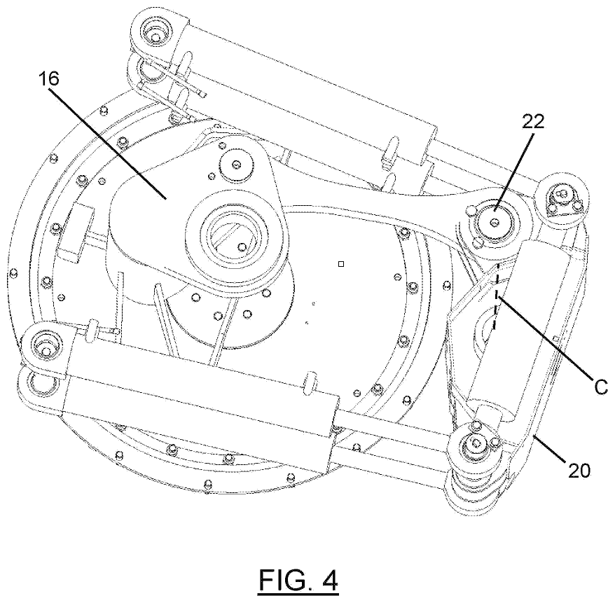

FIG. 4 shows a further embodiment of the detail of FIG. 2;

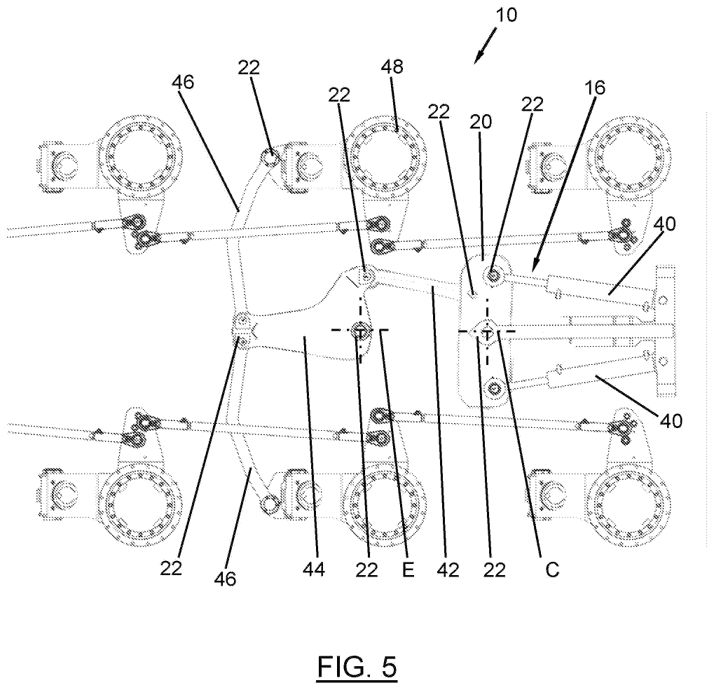

FIG. 5 shows a portion, in particular a rear portion, of the heavy-duty vehicle according to the invention;

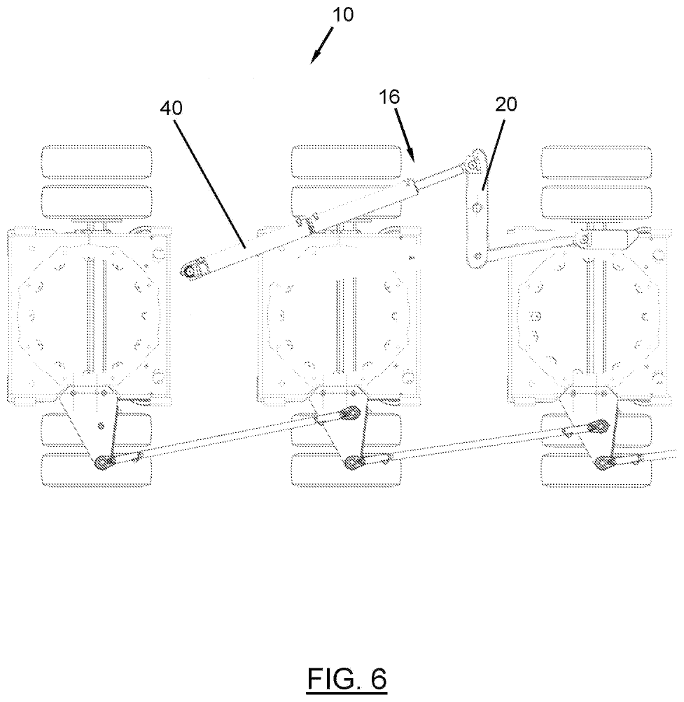

FIG. 6 shows a further embodiment of a portion, in particular of a rear section, of the heavy-duty vehicle according to the invention.

In FIG. 1, a heavy-duty vehicle according to the invention is identified, in general, by the reference sign 10. The heavy-duty vehicle 10 is configured here as a semi-trailer which is connected to a tractor unit 12, which does not form part of the invention. The tractor unit 12 is rotated relative to the semi-trailer 10 about an axis of rotation A, on which the tractor unit 12 is connected to the semi-trailer 10, by an angle α.

FIG. 2 shows, in a detail view, how a steering of the tractor unit 12 is transferred to the semi-trailer 10.

In the exemplary embodiment shown here, the semi-trailer 10 comprises a steering plate 14 which is mounted on the semi-trailer 10 so as to be rotatable about the axis of rotation A. The steering plate 14 is non-rotatably connected to the tractor unit 12.

A steering input element 16 is arranged on the steering plate 14. The steering input element 16, which is designed here as a steering actuator 16, is arranged at a fixed distance from the axis of rotation A. A coupling unit 18, which is designed here as a coupling rod 18, is arranged on the steering input element 16 and pivotable about it, about a pivot axis B. At the end of the coupling unit 18 opposite the steering input element 16, the coupling unit is also pivotably connected to a steering unit 20.

The steering unit 20 is connected in a stationary manner to the heavy-duty vehicle 10 or its vehicle frame, but rotatable about an axis of rotation C (see FIG. 3). This means that a distance between the axis of rotation A and the axis of rotation C cannot be changed.

Upon rotation of the steering plate 14 about the axis of rotation A, the coupling unit 18 is displaced together with the steering actuator 16, as a result of which the steering unit 20 is set in rotation about the axis of rotation C.

At its outer ends, the steering unit 20 has connecting portions 22, at which the steering unit 20 is connected in an articulated manner to piston-cylinder arrangements 24, 26, 28 and 30. The piston-cylinder arrangements 24, 26, 28 and 30 are connected to the heavy-duty vehicle 10 at their ends opposite the steering unit 20 about a particular common pivot axis D or D′. A rotation of the steering unit 20 about the axis of rotation C thus causes the piston-cylinder arrangements 24 and 28 arranged on one side of the steering unit 20 to be extended, for example, that is to say the piston rods connected to the connecting portions 22 are displaced from their respective cylinders whereas the piston-cylinder arrangements 26 and 30 are retracted. In the exemplary embodiment shown, the piston-cylinder arrangements are designed as double-acting hydraulic cylinders.

The steering unit 20 here comprises a variable in length actuating unit 32 which is configured to move the connecting portions 22 connected to it away from or towards the axis of rotation C, i.e. to change a particular distance between the connecting portions 22 connected to the variable in length actuating unit 32 and the axis of rotation C.

Depending on the set distance between the connecting portions 22 and the axis of rotation C, the leverage of the steering unit 20 to the piston-cylinder arrangements 24 to 30 changes. In other words, the distance between the connecting portions 22 and the axis of rotation C can be used to set a ratio of the distance by which a piston of a particular piston-cylinder arrangement is displaced at a specific angle of rotation of the steering unit 20. Since a change in the amount of fluid that is present in a corresponding chamber of a particular piston-cylinder arrangement 24 to 30 causes a proportional actuation of an associated steering device, a transmission ratio of the angle α between the tractor unit 12 and the semi-trailer 10 can be adjusted via the above-mentioned ratio to an extent of an actuation of the steering device associated with the variable in length actuating unit 32.

In the embodiment shown in FIG. 2, the piston-cylinder arrangements 24 and 26 are associated with a first steering device of the heavy-duty vehicle 10 and the piston-cylinder arrangements 28 and 30 are associated with a second steering device of the heavy-duty vehicle 10, and furthermore, in the embodiment shown in FIG. 2, a variable in length actuating unit 32 is associated only with the first steering device, so that only the first steering device of the heavy-duty vehicle 10 comprises a steering device with an adjustable transmission ratio.

The arrangement of two piston-cylinder arrangements 24, 26 or 28, 30, respectively, each for a single steering device is due here to corresponding regulations, which are to be complied with, for example, in the context of German road traffic. Naturally, the same effect could also be achieved using only the piston-cylinder arrangements 24 and 28 or 26 and 30 (or 24 and 30 or 26 and 28).

In FIG. 3, the arrangement of FIG. 2 is shown in a perspective view from below. It can be seen here that the steering plate 14 has a kingpin 34 on its underside, centred on the axis of rotation A, and a steering wedge 36 that is firmly connected to the underside of the steering plate 14. By engaging the kingpin 34 and the steering wedge 36 with, for example, a semi-trailer coupling (not shown), the steering plate 14 can be non-rotatably connected to this semi-trailer coupling.

Furthermore, a pin 38 can be seen in FIG. 3, which is connectable to a vehicle frame of the heavy-duty vehicle 10 via a screw connection on the lower side shown in FIG. 3, and which defines the axis of rotation C about which the steering unit 20 can rotate.

An alternative or additional arrangement of a connecting portion 22 is shown in FIG. 4. In the embodiment shown in FIG. 4, although the actuating units 32 of the embodiment according to FIGS. 2 and 3 are still shown here, the connecting portion 22 on which the steering input element 16 and/or the coupling unit 18 which is connected to the steering input element 16 can be displaced relative to the axis of rotation C of the steering unit 20 in such a way that a transmission ratio of a rotation of the steering plate 14 about the axis of rotation A to a rotation of the steering unit 20 about the axis of rotation C is changed.

FIG. 5 shows a portion, in particular a rear portion, of a heavy-duty vehicle 10 according to the invention, with two piston-cylinder arrangements 40 serving as steering input elements 16 here to exert a force on the steering unit 20 in order to rotate the steering unit 20 about the axis of rotation C. The two piston-cylinder arrangements 40 are provided here in a redundant manner and it is also conceivable to provide only one piston-cylinder arrangement 40.

The steering unit 20 is connected in FIG. 5 via a connecting rod 42 to a pivot lever 44 which is mounted on the vehicle frame of the heavy-duty vehicle 10 about an axis of rotation E. Two steering rods 46 are in turn connected to the pivot lever 44, each of which is coupled to a turntable 48 of a particular wheel assembly comprising at least one wheel (not shown) such that a displacement of a steering rod 46, in particular substantially in the vehicle width direction, causes a rotation of the wheel assembly relative to the vehicle frame of the heavy-duty vehicle 10. The term “turntable” can be applied equally to a turntable of a full floating axle and to a steering arm of a steering arm axis.

In order to implement the basic inventive concept of setting a transmission ratio between a force or displacement path input by a particular steering input element 16 and a force or displacement path, respectively, output to a particular wheel assembly, a variable in length actuating unit 32 can be arranged on a connecting portion 22 between the steering input element 16, i.e. in FIG. 5 at least one of the piston-cylinder arrangements 40, and the steering unit 20 and/or a connecting portion 22 between the steering unit 20 and a bearing about the axis of rotation C and/or a connecting portion 22 between the steering unit 20 and the connecting rod 42 and/or a connecting portion 22 between the connecting rod 42 and the pivot lever 44 and/or a connecting portion 22 between the pivot lever 44 and a bearing about the axis of rotation E and/or a connecting portion 22 between the pivot lever 44 and a steering rod 46 and/or a connecting portion 22 between a steering rod 46 and the wheel assembly or the turntable 48, respectively, or an element connected thereto.

In the embodiment of the heavy goods vehicle 10 shown in FIG. 6, the steering unit 20 is arranged offset from a centre in the vehicle width direction of the heavy-duty vehicle 10. With regard to the features and mode of operation as well as the possible arrangements of a connecting portion 22 of the embodiment shown in FIG. 6, reference is made at this point to the embodiments described above. In the embodiment of FIG. 6, the steering input element 16 is also configured as a piston-cylinder arrangement 40.

1. A heavy-duty vehicle, comprising:
a steering unit mounted on a vehicle frame of the heavy-duty vehicle, wherein the steering unit is rotatable about an axis of rotation of the steering unit; and
a steering input element connected to the steering unit and configured to cause the steering unit to rotate about the axis of rotation of the steering unit,
wherein the steering unit has at least one connecting portion configured to be connected to one or more of a steering device of the heavy-duty vehicle or the steering input element of the heavy-duty vehicle, and
wherein the steering unit comprises at least one actuating unit configured to change a distance of at least one connecting portion relative to the axis of rotation of the steering unit.

2. The heavy-duty vehicle of claim 1, wherein the steering input element is connected to the steering unit via a coupling unit, wherein the coupling unit is connected to the steering unit eccentrically to the axis of rotation of the steering unit, wherein the coupling unit connects the steering input element to the steering unit so that a displacement of the steering input element relative to the vehicle frame of the heavy-duty vehicle causes a rotation of the steering unit relative to the vehicle frame of the heavy-duty vehicle.

3. The heavy-duty vehicle of claim 2, wherein the steering input element comprises a steering actuator that is rotatable around an axis of rotation stationary to the vehicle frame of the heavy-duty vehicle, wherein the steering actuator is arranged at a substantially unchangeable distance from the axis of rotation stationary to the vehicle frame, wherein the steering actuator defines a pivot axis for the coupling unit connected to the steering actuator.

4. The heavy-duty vehicle of claim 3, further comprising a steering plate rotatable relative to the vehicle frame of the heavy-duty vehicle about the axis of rotation stationary to the vehicle frame dependent upon a steering angle of the heavy-duty vehicle, wherein the steering actuator is connected to the steering plate eccentrically to the axis of rotation stationary to the vehicle frame.

5. The heavy-duty vehicle of claim 1, wherein the steering unit comprises a variable in length actuating unit, and further comprising a further steering device, wherein the steering unit is connected both to the steering device and to the further steering device, wherein the at least one actuating unit of the steering unit is configured to displace at least one connecting portion associated with the steering device relative to the axis of rotation of the steering unit.

6. The heavy-duty vehicle of claim 5, wherein the steering unit further comprises a further actuating unit configured to displace at least one connecting portion associated with the further steering device relative to the axis of rotation of the steering unit.

7. The heavy-duty vehicle of claim 6, wherein the at least one actuating unit of the steering unit is configured to displace a pair of connecting portions synchronously relative to the axis of rotation of the steering unit.

8. The heavy-duty vehicle of claim 1, wherein a direction of change in length of at least one of the at least one actuating unit of the steering unit is oriented orthogonally to the axis of rotation of the steering unit.

9. The heavy-duty vehicle of claim 1, wherein the at least one actuating unit is configured as a hydraulic cylinder, a double cylinder, a spindle drive, double spindle drive, a rack drive, a linear unit, or a sliding block unit.

10. The heavy-duty vehicle of claim 4, wherein the steering plate comprises a kingpin and a steering wedge, wherein the kingpin and the steering wedge are configured to engage non-rotatably with a higher-level assembly that is not part of the heavy-duty vehicle.

11. The heavy-duty vehicle of claim 4, wherein a direction of rotation of the steering plate relative to the vehicle frame of the heavy-duty vehicle about the axis of rotation of the steering plate is the same as a resulting direction of rotation of the steering unit about the axis of rotation of the steering unit.

12. The heavy-duty vehicle of claim 4, wherein the at least one actuating unit of the steering unit is arranged outside the steering plate in a direction orthogonal to the axis of rotation of the steering plate.

13. The heavy-duty vehicle of claim 1, wherein the steering device to which the steering unit is connected comprises a hydraulic circuit, wherein the at least one connecting portion associated with the steering device is connected to a piston-cylinder arrangement, wherein the piston-cylinder arrangement is arranged so that a rotation of the steering unit about the axis of rotation of the steering unit causes a relative displacement of piston and cylinder in the piston-cylinder arrangement to actuate a hydraulic circuit of the steering device.

14. The heavy-duty vehicle of claim 4, wherein two piston-cylinder arrangements are associated with each of the steering device and a further steering device, wherein one of the two piston-cylinder arrangements is connected, in each case, to the steering unit at one of connecting portions arranged on two sides of a central plane which extends through the axis of rotation of the steering unit.

15. The heavy-duty vehicle of claim 14, wherein respective ends of the two piston-cylinder arrangements opposite the steering unit are rotatably mounted on a same side of the plane about a common axis substantially parallel to the axis of rotation of the steering unit.

16. The heavy-duty vehicle of claim 1, wherein the at least one actuating unit is variable in length.

17. The heavy-duty vehicle of claim 5, wherein the at least one connecting portion comprises multiple connection portions, and wherein the at least one actuating unit of the steering unit is configured to displace all of the multiple connecting portions relative to the axis of rotation of the steering unit.

18. The heavy-duty vehicle of claim 6, wherein the further actuating unit is variable in length.

19. The heavy-duty vehicle of claim 6, wherein the at least one connecting portion comprises multiple connection portions, and wherein the further actuating unit is configured to displace all of the multiple connection portions relative to the axis of rotation of the steering unit.

20. The heavy-duty vehicle of claim 10, wherein the higher-level assembly comprises a tractor unit and wherein the axis of rotation stationary to the vehicle frame is substantially coaxial with a central axis of the kingpin.

21. The heavy-duty vehicle of claim 14, wherein the one of the two piston-cylinder arrangements is connected, in each case, to the steering unit at one of connecting portions arranged symmetrically on the two sides of the central plane which extends through the axis of rotation of the steering unit.
